(19) United States
(12) Patent Application Publication
(10) Pub. No.: US 2006/0024023 A1
(43) Pub. Date: Feb. 2, 2006

(54) Video playback system and the video playing method thereof

(75) Inventors: Wan-Chi Hsu, Hsinchu City (TW); Yin-Tsung Cheng, Siluo Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 10/989,026

(22) Filed: Nov. 15, 2004

(30) Foreign Application Priority Data
Jul. 28, 2004 (TW) 93122626

(51) Int. Cl. H04N 5/91

(52) U.S. Cl. 386/66

(57) ABSTRACT

A video playback system and the video playing method thereof. The video playback system includes a display panel, a video player for outputting a CCIR video, and a control circuit including a CCIR transformer and a timing controller. The CCIR transformer receives the CCIR video and transforms it to image data. The timing controller receives the image data and outputs a control timing and pixel data for controlling the panel.

This application claims the benefit of Taiwan application Serial No. 93122626, filed Jul. 28, 2004, the subject matter of which is incorporated herein by reference.

### BACKGROUND OF THE INVENTION

1. Field of the Invention

The invention relates in general to a video playback system and the video playing method thereof, and more particularly to a video playback system capable of reducing power consumption, and the video playing method thereof.

2. Description of the Related Art

Due to technological advancements, electronics companies nowadays are not only directing their product development towards light-weight, thin, short, and small components, but are also emphasizing on developing products that are more power conserving. Especially with regards to portable personal entertainment systems, such as portable DVD players, consumers rely primarily on the internal batteries to run the players, and because of such circumstances, it is particularly important that power consumption is considered in the design of the products.

FIG. 1A is a conventional video playback system 100. The video playback system 100 includes a video player 110, a control circuit 130, and a display panel 180. For illustration, display panel 180 is assumed to be an analog display panel. The video player 110 includes a MPEG decoder 112, a video processor 114, and an image encoder 116. MPEG decoder 112 is for receiving encoded data read from compact discs, and outputting decoded data. The MPEG decoder 112 provides decoding methods such as in MPEG1, MPEG2, and MPEG4 etc. The video processor 114 receives decoded data and outputs video data D0 in digital format. Image encoder 116 receives digital video data, and converts digital video data to analog video data A1, such as composite video or S-video data. Also, the image encoder 116 outputs a control timing C1.

The control circuit 130 includes a sync separator 131, a timing controller 132, and an image decoder 134. The sync separator 131 is for receiving the control timing C1 output from the video player 110, then separating the control timing into different sync timings, and finally outputting the control timing C1. The image decoder 134 is for receiving image data A1, then digitizing and decoding image data A1, and finally outputting image data D. The timing controller 132 then converts image data D into analog pixel data P, and outputs analog pixel data P according to timing signal C2.

FIG. 1B shows a block diagram of image decoder 134. The image decoder 134 includes an analog input interface 141, an A/D Converter (ADC) 142, an image processor 143, and a scaler 144. Image data A1 is first received by the analog input interface 141, and is then fed into the ADC 142 to be converted into digital data, and is in turn processed by the image processor 143 and the scaler 144 to output image data D. The image processor 143 can perform various controls such as brightness, hue, and gamut adjustments, while the scaler 144 can perform image size scaling.

Since conventional displays, such as CRT televisions having control circuit 130 and display panel 180 as described above, are only built to receive analog signals. Thus, the video player 110 has to encode the internally processed digital signals into analog image data A1 before transferring. Consequently, conventional video playback systems must perform multiple analog-to-digital (A/D) and digital-to-analog (D/A) conversions, and resulting in signal data loss, overuse of power consumption, and unnecessary waste of costs and resources etc.

To better illustrate, the image encoder 116 for example first performs a D/A conversion, then the image decoder 134 performs a A/D conversion, then the timing controller 132 again performs another D/A conversion. While performing A/D or D/A signal conversions, a greater amount of power is consumed, and since conventional video playback systems require signals to go through multiple levels of A/D and D/A conversions, power consumption can not be effectively reduced.

### SUMMARY OF THE INVENTION

It is therefore an object of the invention to provide a video playback system capable of reducing power consumption, and the video playing method thereof.

The International Radio Consultative Committee (CCIR) interfaces are commonly used as the interface between video decoders and display control ICs (Scaler, Timing Controller), for applying internally to the display system. The CCIR interface under present invention is being implemented, in novelty, between the video playback system and the display system. By such implementation, the D/A conversions are no longer required in video playback systems, and in digital display systems, the A/D conversions are no longer required as well. Thus, the system costs can be effectively reduced, while arriving at better picture quality. Similarly, for analog playback systems, by eliminating the D/A conversion originally required in video players, better picture quality can also be achieved.

The invention achieves the above-identified object by providing a video playback system, including a video player, a control circuit, and a display panel. The video player is for outputting a CCIR video. The control circuit includes a CCIR transformer and a timing controller. The CCIR transformer if for receiving and converting the CCIR video into image data. The timing controller is for receiving image data, and outputting a control timing and image data. The display panel is for receiving image data and control timing, and outputting picture frames accordingly.

The invention achieves another above-identified object by providing a method of displaying video. First, the CCIR transformer is utilized to receive the CCIR video and transform the CCIR video to image data. Next, utilizing the timing controller, image data is received, and then pixel data and a control timing are outputted. Then, according to pixel data and the control timing, picture frames are displayed on the display panel.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIGS. 1A and 1B show illustrations of a conventional video playback system.

FIG. 2 is block diagram of a video playback system 200 according to an embodiment of the invention.

FIG. 3 shows block diagram illustrating the CCIR transformer 234.

### DETAILED DESCRIPTION OF THE INVENTION

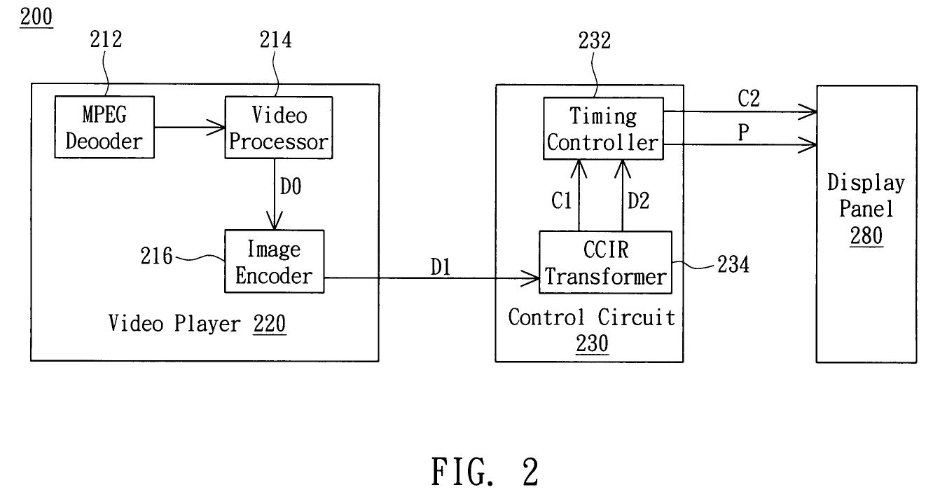

FIG. 2 is block diagram of a video playback system 200 according to an embodiment of the invention. Video playback system 200 is, for example, a portable DVD player, and includes a video player 200 and a display module. The display module includes control circuit 230 and a display panel 280. Video player 220 is for outputting a CCIR video D1. Control circuit 230 is for receiving the CCIR video D1 and outputting pixel data P and control timing C2 accordingly. Display panel 280 then displays picture frames according to control timing C2 and pixel data P. The CCIR video is the video format standard set out by the International Radio Consultative Committee (CCIR).

Video player 220 includes a MPEG decoder 212, a video processor 214, and an image encoder 216. MPEG decoder 212 is for receiving and decoding encoded data into decoded data for output. The decoded data are for instance data read from a DVD. Video processor 214 receives the decoded data and outputs the video data accordingly, then image encoder 216 in turn receives the video data and outputs a CCIR video D1 in digital format. The CCIR video D1 is for example a CCIR 601/656 4:2:2 of YCbCr format.

Control circuit 230 includes a CCIR transformer 234 and a timing controller 232. CCIR transformer 234 receives the CCIR video D1, then transforms CCIR video D1 into image data D2, and extracts control timing C1 from image data D2. Timing controller 232 then receives image data D2 and control timing C1, and outputs pixel data P and control timing C2 accordingly.

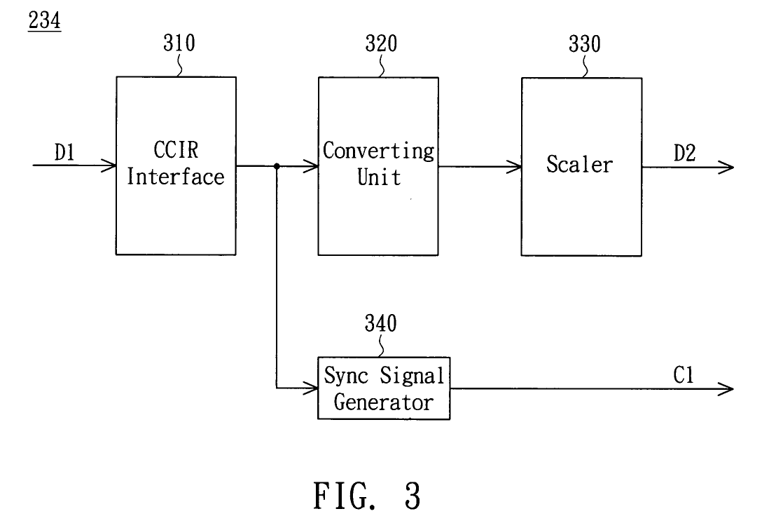

FIG. 3 shows a block diagram illustrating the CCIR transformer 234. CCIR transformer 234 includes a CCIR interface 310, a sync signal generator 340, a converting unit 320, and a scaler 330. CCIR interface 310 is for receiving CCIR video D1. Converting unit 320 receives CCIR video D1 via CCIR interface 310 and outputs a RGB video. The scaler 330 receives and scales the RGB video, and outputs image data D2. Sync signal generator 340 receives CCIR video D1 via CCIR interface 310, and extracts a sync timing contained in CCIR video D1 to generate a control timing C1.

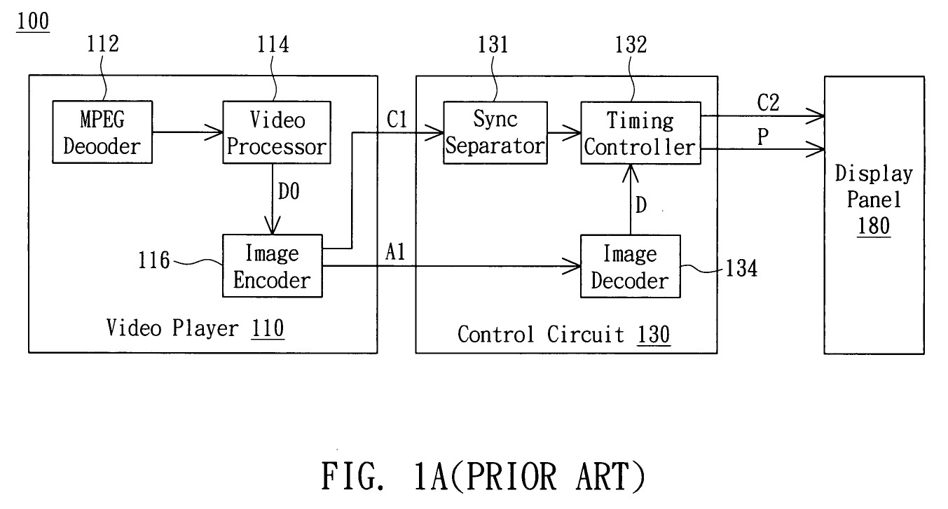

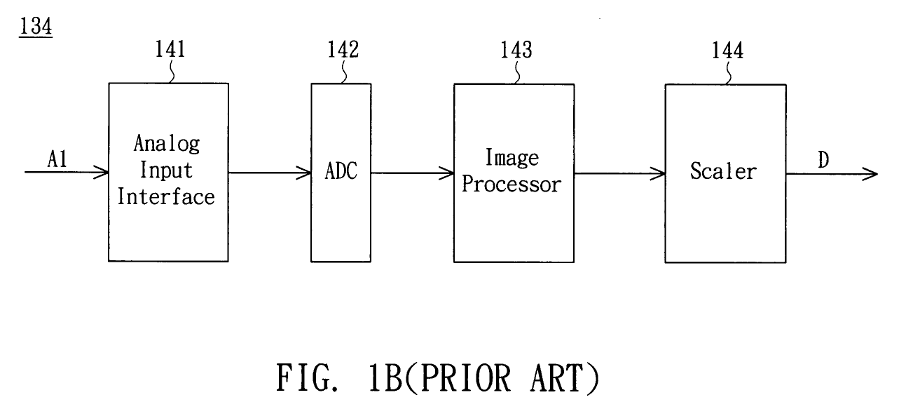

The difference between the embodiment of present invention (FIG. 2) and the conventional embodiment (FIG. 1) is primarily that the present invention utilizes the CCIR interface to replace the conventional composite video signal (CVBS) or S-Video interfaces. Since the die size of CCIR transformer is much smaller compared to that of CVBS or S-Video video decoders, the costs can be effectively reduced.

In addition, for the CCIR transformer according to the embodiment of present invention, the input video signals are not required to undergo data conversions through ADCs, thus data loss resulting from analog to digital conversions can be prevented, and data can be presented as picture frames in the most realistic form.

Furthermore, the brightness, hue and gamut adjustments originally handled by conventional image processors can now be performed by video player 220. Therefore, functions required for CCIR transformer 234 can be greatly reduced, which directly translates to the reduction of die size and manufacturing costs

The display panel 280 according to the embodiment of the invention can be in analog format or in digital format. When display panel 280 displays in analog format, pixel data P output by timing controller 232 is also in analog format, such as in interlaced RGB format; when display panel 280 displays in digital format, pixel data is also in digital format, such as in LVDS, DV1 etc.

The video play back system as according to above mentioned embodiment of the present invention can be concluded to have the following advantages:
1. Costs reduction
Without having to use the image decoder for decoding, costs of manufacturing image decoder can be reduced, thus effectively reducing overall system costs.
2. Good picture quality
With this novel system architecture, video signals undergo neither digital to analog conversions, nor analog to digital conversions. Hence, the data can be prevented from being lost during conversions, and thus the data is presented as picture frames in the most realistic form.
3. Conserve power consumption
The videos output by the video player are digital format CCIR videos; therefore, during output, the video player does not need to perform D/A conversions, and the CCIR converter in the control circuit does not need to perform A/D conversions either. Since the invention eliminates the unnecessary A/D and D/A format conversions, power consumption can be effectively reduced.
4. Control circuit can be integrated on the display panel, allowing the size of the video playback system to reduce even further.

While the invention has been described by way of example and in terms of a preferred embodiment, it is to be understood that the invention is not limited thereto. Rather, it is intended to cover various modifications and similar arrangements and procedures, and the scope of the appended claims therefore should be accorded the broadest interpretation so as to encompass all such modifications and similar arrangements and procedures.

What is claimed is:

1. A video playback system, comprising:
a video player for outputting a CCIR video;
a control circuit, comprising:
a CCIR transformer for receiving and transforming the CCIR video to image data; and
a timing controller for receiving the image data and outputting a control timing and pixel data; and
a display panel for receiving the pixel data and the control timing for controlling the panel to display picture frames.

2. The video playback system according to claim 1, wherein the CCIR transformer comprises:
a CCIR interface for receiving the CCIR video;
a synchronous signal generator for extracting the control timing from the CCIR video; and
a signal converter for receiving the CCIR video via the CCIR interface and outputting the image data.

3. The video playback system according to claim 2, wherein the signal converter comprises:
a converting unit for receiving the CCIR video and outputting a RGB video; and
a scaler for receiving and scaling the RGB video and outputting the image data.

4. The video playback system according to claim 1, wherein the CCIR video and the image data are in digital format.

5. The video playback system according to claim 1, wherein the pixel data is in analog format.

6. The video playback system according to claim 1, wherein the pixel data is in digital format.

7. The video playback system according to claim 1, wherein the video player comprises:
a MPEG decoder for receiving and decoding encoded data and outputting decoded data;
a video processor for receiving the decoded data and outputting video data; and
an image encoder for receiving the video data and outputting the CCIR data.

8. A method of video playing, comprising:
utilizing a CCIR transformer to receive and transform CCIR video to image data;
utilizing a timing controller to receive the image data and to output pixel data and a control timing; and
displaying picture frames on a display panel responsive to the pixel data and the control timing.

9. The method of video playing according to claim 8, wherein the step of utilizing a CCIR transformer to receive and transform CCIR video to image data comprises:
receiving the CCIR video; and
converting the CCIR video into a RGB video; and
scaling the RGB video; and
outputting the image data.

10. The video player system according to claim 8, wherein the CCIR video and the image data are in digital formats.

11. The video player system according to claim 8, wherein the pixel data is in analog format.

12. The video player system according to claim 8, wherein the pixel data is in digital format.

13. A display module, comprising:
a control circuit, comprising:
a CCIR transformer, receiving and transforming a CCIR video to image data; and
a timing controller, receiving the image data, and outputting a control timing and pixel data; and
a display panel for receiving the pixel data and the control timing and displaying picture frames on the display panel responsive to the pixel data and the control timing.

14. The display module according to claim 13, wherein the CCIR transformer comprises:
a CCIR interface for receiving the CCIR video; and
a signal converter for receiving the CCIR video via the CCIR interface and outputting the image data responsive to the CCIR video.

15. The display module according to claim 14, wherein the signal converter comprises:
a converting unit for receiving the CCIR video and outputting a RGB video; and
a scaler for receiving and scaling the RGB video and outputting the image data.

16. The display module according to claim 13, wherein the CCIR video and the image data are in digital formats.

17. The display module according to claim 13, wherein the pixel data is in analog format.

18. The display module according to claim 13, wherein the pixel data is in digital format.
